(19) United States
(12) Patent Application Publication
(10) Pub. No.: US 2008/0252434 A1
(43) Pub. Date: Oct. 16, 2008

(54) Wheel status monitoring system

(76) Inventor: Nelson Leatherman, Rockhill, SC (US)

Correspondence Address: MICHAEL RIES, 318 PARKER PLACE, OSWEGO, IL, 60543, US

(21) Appl. No.: 11/784,919

(22) Filed: Apr. 10, 2007

(51) Int. Cl. B60C 23/20

(52) U.S. Cl. 340/438

(57) ABSTRACT

The present invention relates to a tire pressure monitoring system for a vehicle using temperature sensors mounted on axles in close proximity to each wheel to detect an increase in temperature generated by a compromised tire and conducted to the axle. The temperature information for each wheel is sent wired or wirelessly to a processor where the magnitude of the temperature is compared with the temperature of an uncompromised wheel. A significant increase in the temperature difference causes an alarm signal to be sent to a monitoring panel along with information that indicates to the driver which wheel is compromised.

### TECHNICAL FIELD & BACKGROUND

The present invention generally relates to the field of monitoring systems for the condition of wheels on a vehicle. More specifically, the present invention relates to monitoring systems for status and alerts on tire pressure, tread failure, wheel bearing malfunction, etc. while the vehicle is moving.

There is a constant search for devices that ascertain the status of a wheel while moving on the highway and is most particularly true when towing multi-axle trailers. In the multi-axle situation the driver cannot easily see rear or innermost deflated or malfunctioning tires. Loss of tire pressure, tread failure, and bearing malfunctions all generate increased heat due to greater friction while the vehicle is in motion. This increase in temperature is utilized by the present invention to provide early warning information to the driver concerning the status of the vehicle's wheels or tires or other closely related parts.

Similar products on the market today measure the pressure of the tire from a direct attachment of a pressure sensor to the tire. Other similar products on the market today measure the pressure of the tire by remote or direct measurement of the temperature of the tire. A common drawback to these devices is the difficult means required to communicate the temperature or pressure signals to the amplifier, processor or alarm circuits of the system, because of the motion of the tire. In the other similar products, the remote temperature measurement is done by sensors that sense the thermal radiation of the heat generated by a compromised or deflated tire. Thermal radiation is the energy radiated from hot surfaces as electromagnetic waves. It does not require a medium for propagation. The hotter an object is, the more light or electromagnetic waves it emits. And, as the temperature of the object increases, it emits most of its light at higher and higher energies. (Higher energy light means shorter wavelength light.) The drawback to these devices is that dirt and other particles picked up by the moving vehicle can defeat this sensing method by blocking the electromagnetic waves or light.

The present invention relies on the principle of thermal conduction for assessing the status of wheels on moving vehicles. Thermal conduction is the transfer of thermal energy within a material (medium for heat propagation) without any motion of the material as a whole. In the present invention temperature sensors are mounted in thermal contact (direct mechanical contact) with the axle assemblies in close proximity to each wheel (the metal of the axle is the material of medium). The heat of the moving or rotating tire or wheel is thermally conducted along the metal connections to the axle and to the temperature sensors. Temperature sensors in contact with the axles solves the previous problems of blocked communications, since the axles are fixed in one place on the vehicle and simpler wired connections can be made between the sensors and amplifiers, processors or alarms.

The temperature sensors convert the thermal energy to an electrical voltage which is sent to a central processing unit (CPU) or signal processor or programmable electronic circuit or group of discrete components and integrated circuits, where the magnitudes of the temperatures of each wheel are compared. A significant increase in the temperature of a wheel causes an alarm signal to be sent to a monitoring panel, which displays information to the driver as to which wheel or location of wheel is compromised and the extent or magnitude of the malfunction. The position of the lights on a display panel indicate the location of the wheel that is malfunctioning and the color of the light indicates the magnitude of the malfunction or dysfunction. The system of the present invention may use a wired or wireless communication system between the sensors and the signal processor, and/or between the signal processor and the display. Depending on the situation, the display may be located in the cab of a vehicle or on a towed vehicle in a position where it can be viewed through the rear-view mirrors of the towing vehicle. The system of the present invention operates with any number of wheels or tires on each side of an axle and with any number of axles. The system is applicable to cars, trucks, buses, and trailers (semi, boat, horse, utility, house, etc.) The system provides an indication of problems related to any malfunction that generates heat in a wheel such as wheel bearing malfunction, low tire pressure, and brake malfunction.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an environmental drawing of a truck towing a dual-axle trailer having a wheel status monitoring system, in accordance with an embodiment of the present invention.

FIG. 2 illustrates an environmental drawing of a single axle trailer having wheel status monitoring system using thermocouple temperature sensors in accordance with an embodiment of the present invention.

FIG. 3 illustrates an electrical block diagram of the monitoring system shown in FIG. 2, in accordance with an embodiment of the present invention;

FIG. 4 illustrates a detailed schematic of the signal processing circuit and display shown in FIGS. 2 and 3, in accordance with an embodiment of the present invention.

FIG. 5 illustrates a detailed schematic of the power supply used by the signal processing circuit of FIG. 4, in accordance with an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise. Values for resistors and capacitors are exemplary and correspond to the embodiment described. The manufacture IC chip part numbers are exampled for the sake of the embodiment described.

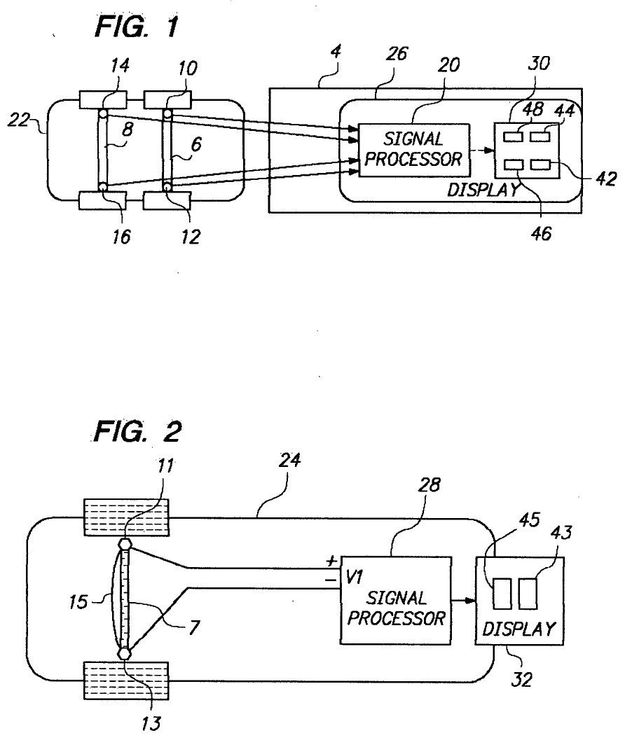

Referring now to FIG. 1, shown is a truck 4 having a cab 26 and a trailer 22. The trailer 22 as shown has two axles 6 and 8. Also, FIG. 1 shows a left temperature sensor 10 mounted in thermal contact with the metal axle 6 in close proximity to the left wheel (as close as possible for convenient mounting of the sensor to the axle without interfering with the rotation of the wheel) and a right temperature sensor 12 mounted in thermal contact with the metal axle 6 in close proximity to the right wheel. Also, FIG. 1 shows a left temperature sensor 14 mounted in thermal contact with the metal axle 8 in close proximity to the left wheel and a right temperature sensor 16 mounted in thermal contact with metal axle 8 in close proximity to the right wheel. The temperature sensors 10, 12, 14, and 16 in the embodiment shown in FIG. 1 may be any contact temperature sensor such as thermistors, thermocouples, RTDs, etc.

On any vehicle the tire, wheel and axle are all thermally conductive and except for the tire are all made of metals. Also, most modern tires have metal embedded in the treads of the tire. When a wheel heats up due to a malfunction, heat transfer occurs by thermal conduction from the wheel to the axle causing the temperature of the axle to increase. Heat transfer by thermal conduction involves transfer of thermal energy within a material without any motion of the material as a whole. The rate of heat transfer depends upon the temperature gradient and the thermal conductivity of the material. For metals, the thermal conductivity is quite high. The temperature sensors 10, 12, 14, and 16 detect the increase in the respective axle temperatures resulting from a wheel malfunction and convert the temperatures to voltages. The voltage from each sensor is transmitted, wired or wireless, to a signal processing unit 20 where the temperature of each wheel is compared with a paired wheel or, statistically, with the other wheels to determine whether or not there is excessive heating in a particular wheel. The type of temperature sensor used in the system determines the circuit of the signal processor and may or may not use a microprocessor and/or programmable circuit or custom circuit or combination of discrete components and integrated circuits. If a significant increase in temperature is detected, a signal is transmitted (wired or wireless) to a visual/auditory display 30 in the cab 26 of the towing vehicle 4. The display panel 30 provides visual and/or auditory information concerning the location of the compromised wheel and the degree of malfunction. In the embodiment shown in FIG. 1, the display panel 30 has a multicolored light representing each wheel; the right front wheel by multicolor light 42 (sensor 12), the left front wheel by light 44 (sensor 10), the right rear wheel by light 46 (sensor 16), and the left rear wheel by light 48 (sensor 14).

As an example, a malfunction in the left rear wheel or tire (low pressure etc) near sensor 14 causes increased heating in the left rear wheel and in the portion of the axle in close proximity. This thermal energy is conducted from the wheel to the axle and increases the temperature of sensor 14. The signal processor 20 conditions and analyzes the temperature signal from sensors 14 and 16 and determines that excess heat is being generated in the left rear wheel. Logic signals from the signal processor 20 cause multicolor light 48 to turn from green for normal operation to yellow for a warning condition or alert and from yellow to red for a danger condition or alert. Also, the position of multicolor light 48 on the display panel 30 indicates the left rear wheel is the malfunctioning wheel.

In addition, it should be noted that the display 30 could be located on the towed vehicle and viewed through the rear-view mirrors of the towing vehicle.

FIG. 2 shows a specific embodiment in which the monitoring system is located within a single-axle trailer 24 and uses thermocouples (copper-constantan) as the temperature sensors, 11 and 13. In this embodiment, the signal processor 28 is located in the trailer 24 and the display panel 32 is prominently positioned on the trailer for viewing through the rear-view mirrors of a towing vehicle (not shown).

The monitoring system can be replicated any number of times to accommodate multiple axles. By electrically connecting thermocouples 11 and 13 in series with constantan wire 15, as shown in FIG. 2, a difference in temperature is measured between the paired wheels on axle 7. The advantage of this arrangement is that ambient temperature is subtracted out of the wheel temperature measurement allowing the temperature of one wheel 11 to be compared directly to the temperature of the opposite wheel 13 on the same axle 7. For the sake of discussion, the left wheel thermocouple 11 is arbitrarily chosen as the ‘positive’ wheel and the right wheel thermocouple 13 is the ‘negative’ wheel of the pair on the axle 7. If the temperature of the left wheel 11 on axle 7 increases above that of the right wheel 13 the voltage output V1 of the thermocouple pair on axle 7 will be positive. Conversely, if the temperature of the right wheel 13 on axle 7 increases above that of the left wheel 11 on the axle 7, the voltage output V1 of the thermocouple pair on axle 7 will be negative. Thus, a positive V1 carries information concerning left wheel 11 dysfunction whereas, a negative V1 carries information concerning right wheel 13 dysfunction on axle 7.

Preliminary studies have shown that a wheel deflated by 5 psi runs about 3 C.° degrees centigrade hoffer than a paired wheel with normal inflation pressure. Since each copper-constantan thermocouple delivers an EMF of approximately 50 uv/C.° microvolts per degree centigrade, a temperature difference between paired wheels of 3 C.° degrees centigrade because of a 5 psi pressure difference results in a voltage V1 of about 0.15 mV millivolt. V1 will be + or − depending on whether the right or left wheel tire is dysfunctional. Voltage V1 is sent to the signal processor 28 which, for the embodiment shown in FIG. 2, provides amplification, level detection and digital logic processing that allows comparisons of the temperatures of the right and left wheels. As a result of the comparisons, right wheel warning light 43 and left wheel warning light 45 on display 32 will light up to indicate whether right wheel 13 or left wheel 11 is dysfunctional and the extent of the malfunction. No malfunction or normal operation is indicated by the presence of a green color light, a warning alert by a yellow colored light, and a danger alert by a red color light.

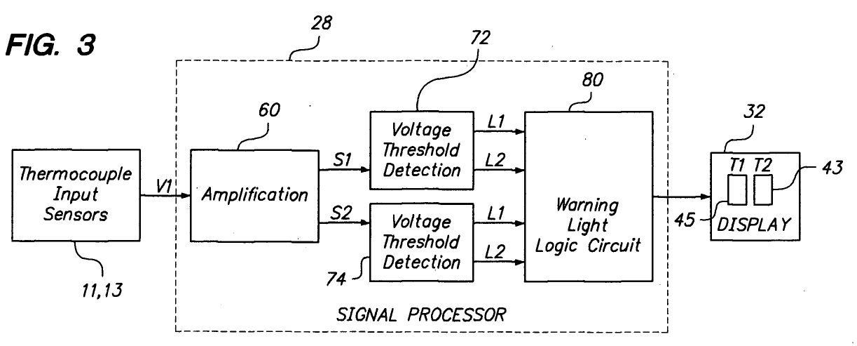

FIG. 3 shows a detailed block diagram of the signal processor shown in FIG. 2 which carries out the comparison and display functions for the left and right wheels of axle 7. The voltage output V1 of the thermocouple pair 11, 13 is input into the amplification section 60 of the signal processor 28. The amplification section 60 produces two outputs; S1 contains information concerning a left wheel malfunction, and its S2 contains the information concerning a right wheel malfunction. S1 and S2 provide the input to two identical level detectors 72 and 74 respectively. Each level detector produces two logic signals L1 and L2. The logic circuit 80 interprets the logic signals L1 and L2 to determine if excessive heating exists in a wheel and sets the color of the appropriate warning light 43 or 45 on the display 32. For example, level detector 72 determines if the input signal S1 is greater than either of two set voltage levels representing predetermined axle temperatures, for example 5 C.° and 10 C.°. When S1 exceeds the lower threshold voltage, the logic signal L1 changes state and the warning light 45 changes from green to yellow indicating a warning level magnitude of malfunction. When S1 exceeds the higher threshold voltage, the logic signal L1 changes state and the warning light 45 changes from yellow to red indicating a danger level magnitude of malfunction. The same example may be extended to level detector 74 with input S2 and warning light 43 and the same indications of level of magnitudes of malfunction.

It should be noted that the single axle monitoring system shown in FIGS. 2 and 3 can be replicated to provide monitoring of a multiplicity of axle systems.

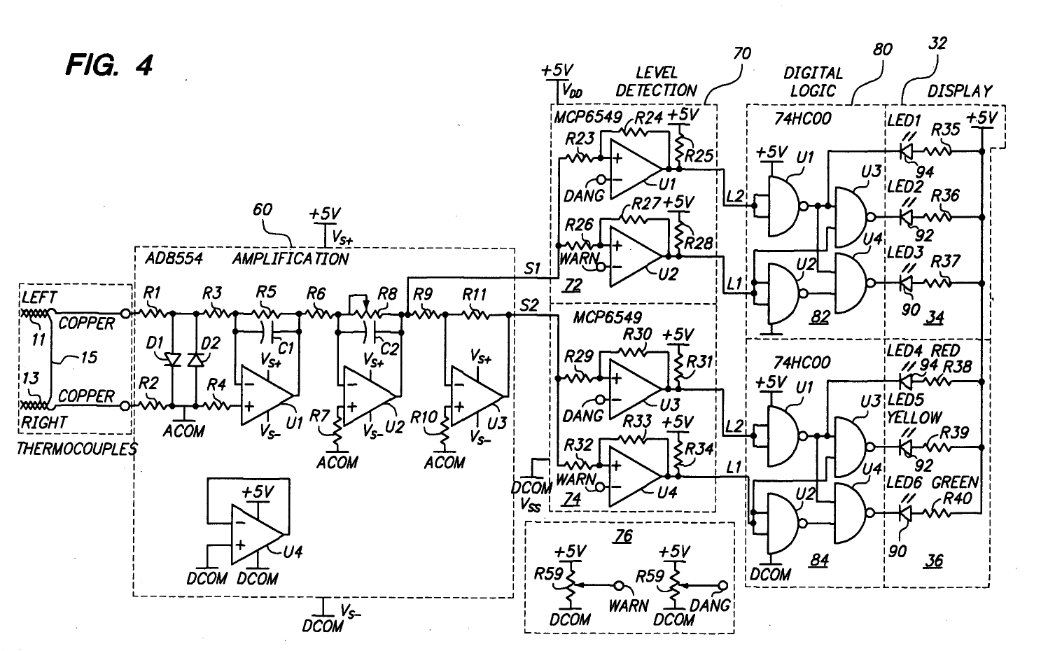

FIG. 4 shows a detailed schematic of the signal processing circuit 28 for the embodiment shown in FIGS. 2 and 3. The signal processing circuit 28 is segmented into an amplification section 60 using differentially connected inverting operational amplifiers and an inverter, a voltage level detection section 70, a digital logic section 80, and display section 32.

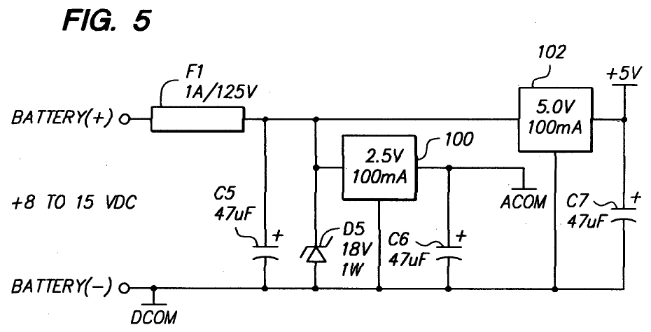

FIG. 5 shows a detailed schematic of the power supply converter using the single ended power supply of the vehicle battery as input which may be 12 or 24 volts DC. The converter consists of capacitor CS for noise or AC filtering. The converter uses a fixed 5 volt voltage regulator U4 to provide a single ended power supply having a +5 volt output and the digital system common DCOM or system ground for the logic circuits and comparators. The converter uses an zener diode D5 to provide voltage spike protection for voltage regulator U3. The converter uses a fixed 2.5 volt voltage regulator U3 to provide a DC +2.5 volt supply voltage ACOM which is half of the +5 volt supply. This is used to provide a virtual common ACOM which is half way between the system ground and +5 volts. When the virtual common ACOM is connected to the noninverting inputs of op-amps U1-U3 through a bias resistor, the op-amps operate in an inverting amplification mode with an output swingcentered about the virtual common ACOM. Capacitors C6 and C7 provide further noise filtering on the voltage regulated output.

In FIG. 4, the left 11 and right 13 thermocouples are connected in series with constantan 15 to provide a differential input voltage to the amplification section 60 over copper wires. Resistors R1 and R2 with example values of 100 ohms and diodes D1 and D2 provide input current and voltage overload protection. The right thermocouple 13 input is connected to the analog common ACOM through current limiting resistor R2. The left thermocouple input is connected to amplification section 60 through current limiting resistor R1.

The amplification section 60 produces two outputs: the positive left wheel voltage, S1, and the negative right wheel voltage, S2. Output of amplification section 60 is accomplished in three stages using low noise, identical low drift integrated circuit operational amplifiers U1-U3 found in the IC package Analog Devices, AD8554. The unused op-amp U4 is connected as shown to prevent its unused inputs from having deleterious effects on the other op-amps U1-U3.

The first stage of amplification section 60 consists of op-amp U1, feedback resistor R5 (100 k ohms), filter capacitor C1 (0.1 microfarad), input resistor R3 (1 k ohms) and bias compensation resistor R4 (1 k ohms). The inverting input of U1 is connected to one of the thermocouple differential inputs through input resistor R3 and to the output of U1 through feedback resistor R5 and filter capacitor C1. The non-inverting input is connected to virtual common ACOM through bias compensation resistor R4. The positive power supply input of U1 is connected to the +5 volt supply and the negative power supply input of U1 is connected to DCOM or system ground or 0 volt or common line of the +5 volt supply. Since ACOM is a positive voltage with half the voltage of the +5 volt supply, op-amp U1 operates with a split + and − supply with the amplified output of U1 swinging between + and −2.5 volts centered about ACOM. The first stage U1 provides a fixed inverting gain of 100 set by the values of feedback resistor R5 and input resistor R3.

The second stage of amplification section 60 consists of op-amp U2, input resistor R6 (3.3 k ohms), feedback potentiometer R8 (100 k ohms max.) and filter capacitor C2 (0.1 microfarad). The inverting input of U2 is connected to the output of the first stage through input resistor R6 and to the output of U2 through feedback potentiometer R8 and filter capacitor C2. Again, U2 is configured to be an inverting amplifier in operation since analog common voltage ACOM is connected to the non-inverting input through bias compensation resistor R7 (3.3 k ohms). U2 is connected to the same power supply inputs as U1. The second stage U2 provides an adjustable inverting gain between 1 and 30 set by the potentiometer R8 and input resistor R6. The output of U2 provides the output S1. The total gain of first and second stage of amplification section 60 is therefore adjustable between 100-3000.

The second output, S2, is obtained by inverting the S1 signal through an inverting unity gain consisting of op-amp U3, input resistor R9 (10 k ohms) and feedback resistor R11 (10 k ohms). Again, U3 is configured to be an inverting amplifier in operation due to bias compensation R10 connected between the non-inverting input and ACOM. U3 is connected to the same power supply inputs as U1.

The capacitors C1 and C2 in the feedback paths of U1 and U2 provide filtering of noise that might arise with high amplification. S1 contains information concerning a possible malfunction in the left wheel and S2 contains information concerning a possible malfunction in the right wheel.

As mentioned in the example above referring to FIG. 2, deflation of a tire on one of the wheels by 5 psi results in the thermocouples providing a voltage V1 of about 0.15 millivolts. The amplification section 60 having a gain of between 100 and 3000 amplifies V1 to voltage levels S1 and S2 suitable for comparison by the level detection circuit 70.

The level detection circuit 70 provides two identical level detection circuits 72 and 74, using a quad comparator IC chip (Microchip, MCP6549). Each level detector circuit 72 and 74 has inputs coupled to the outputs S1 and S2 respectively. Each level detector circuit 72 and 74 utilizes two comparators of the quad comparator having separate logic outputs L1 and L2. Each of the comparators U1-U4 are connected to gain setting feedback resistors R24, R27, R30, and R33 (1 M ohms each) and input resistors R23, R26, R29 and R32 (10 k ohms each), to provide positive feedback and a small amount of hysteresis. This insures that the comparators in U1-U4 are positively driven to one of the two level logic outputs based on voltage level differences at their inputs. The pull-up resistors R25, R28, R31, and R34 (100 k ohms each) each connected to +5 volt supply provide the TTL compatible logic level outputs L1 and L2.

In the absence of any wheel malfunction both logic signals L1 and L2 are set low. In the first comparator of level detector 72 or 74 the input is compared to a low threshold voltage, WARN, that represents the warning temperature level. When the input S1 or S2 exceeds the WARN voltage level the logic output L1 goes high at the respective detector 72 or 74. The second comparator of detectors 72 or 74 compares the input S1 or S2 to the high voltage threshold, DANG, that represents the danger temperature level. When the input S1 or S2 exceeds the DANG voltage level the logic output L2 goes high at the respective detector 72 or 74.

The threshold voltage levels, WARN and DANG, are set by the voltage dividers comprising potentiometers R59 (10 k ohms) and R60 (10 k ohms) connected between the +5 volt supply and DCOM as shown in the reference voltage generator 76. For the purpose of discussion, a 3 C.° temperature differential (5 psi deflation) represents a warning level and a 6 C.° temperature differential (10 psi deflation represents a danger level). The above values are for example purposes only—exact temperatures, pressures, and voltages may vary depending upon specific applications. Considering the amplification circuit 60 to be set to provide a gain of 2000, then the WARN voltage level would be set to 0.3 volts in order to set L1 high when the wheel reached a low level of dysfunction and the DANG voltage level would be set to 0.6 volts in order to set L2 high when the wheel reach a high level of dysfunction The digital logic circuit 80 consists of identical digital logic circuits 82 and 84 corresponding to the generation of signals for the right and left wheels respectively. The logic signals L1 and L2 from the threshold detection circuits 72 or 74 are output to identical digital logic circuits, 82 and 84, which drive the multicolor display lights 34 and 36 representing the left and right wheels respectively. Each of the logic circuits in 82 and 84 uses four of the NAND gates in a quad NAND gate (Toshiba, TC74HC00). Each of the logic circuits 82 and 84 provide three outputs to drive the different colored LED lights 90, 92 and 94. In display 36, resistors R38, R39 and R40 (120 ohms each) provide the bias voltage drops to drive LEDs 90, 92 and 94 respectively from logic levels signals produced by logic circuit 84. The same is true of the function of resistors R35, R36, and R37 for each of the three LEDs in display 34. Three of the four logic states of L1 and L2 are decoded by logic circuits 82 and 84 to turning on one of the three lights 90, 92 and 94. A fourth logic state would not occur unless the level detection circuits providing L1 and L2 were not working properly.

In the implementation shown in FIG. 4, a warning display 32 for each pair wheel (like the wheels 43, 45 on axle 7 in FIGS. 2 and 3) has three colors produced by a green LED 90, a yellow LED 92 and a red LED 94. When lit, the color of the lights indicate the magnitude of the voltage provided by the thermocouple pair. The higher the voltages S1 or S2 from the amplified thermocouple pair, the higher the temperature of the wheel axle and the greater the dysfunction indicated by the color of the fights.

The following operation follows logic circuit 84 and display 36. The green LED 90 is fit when both L1=low and L2=low and inverted by NAND gate U1 and U2 respectively and provide two high signals at the two inputs of NAND gate U4 which outputs an active low and causes LED 90 to be forward biased through R40 which provides current limiting and bias for the LED 90. This occurs when neither threshold WANG or DANG is exceeded and L1 and L2 are low and the wheel is well within the range of temperatures for a properly operating wheel.

The yellow LED 92 is lit when L1=high and L2=low, and L2 is inverted by U1 and U1 and L1 provide two high signals at the two inputs of NAND gate U3 which outputs an active low and causes LED 92 to be forward biased through R39 which provides current limiting and bias for the LED 92. This occurs when the low or WANG threshold is exceeded and the wheel has reached the warning temperature of an improperly operating wheel or tire.

The red LED 94 is lit when LI=high and L2=high, and L2 is inverted by U1 and the low output of U1 provides an active low and causes LED 94 to be forward biased through R38 which provides current limiting and bias for the LED 94. This occurs when both the low WARN and the high DANG thresholds are exceeded and the wheel has reached the danger temperature of an improperly operating wheel or tire.

While the present invention has been related in terms of the foregoing embodiments, those skilled in the art will recognize that the invention is not limited to the embodiments depicted. The present invention can be practiced with modification and alteration within the spirit and scope of the appended claims. Thus, the description is to be regarded as illustrative instead of restrictive on the present invention. Indeed, it is possible to include audible alerts or audible alerts in addition to visual displays discussed above or vibratory alerts. The vibratory alert is a shake or tactual alert that vibrate or shakes a device in contact with a person to provide a sensation which is felt by the person. It is also, possible to combine or integrate the functions of the display or warning lights, such as using a single alphanumeric display to textually display which wheel on which axle has one or more warning conditions. Also, a single CPU might accomplish some or all of the functions carried out in the signal processing, voltage threshold detection, warning light logic circuit for one or both wheels and one or many axles. In this case, the CPU is more adept at processing, controlling and outputting the larger number of warning displays and audible alerts involved with both wheels on one or more axles, even if the warning displays use a textual format as mentioned above.

What is claimed is:

1. An apparatus for monitoring wheel status on a vehicle comprising:
temperature sensors mounted in thermal contact with axles in close proximity to wheels;
a signal processor to analyze signals from the temperature sensors representing temperatures of the wheel; and
a warning device coupled to the signal processor to alert a driver of the vehicle of a wheel malfunction.

2. The apparatus in claim 1 wherein the temperature sensors comprise a selected one of thermocouples, thermistors, and resistive temperature devices (RTD).

3. The apparatus of claim 1 wherein the signals from the temperature sensors are conditioned by amplifiers that are part of the signal processor.

4. The apparatus of claim 1 wherein the signal processor comprises a selected one of a microprocessor, a custom electronic circuit, and a combination of microprocessor and custom electrical circuit.

5. The apparatus of claim 1 wherein the signal processor determines by statistical means the existence of excess heat in a wheel.

6. The apparatus of claim 1 wherein the signal processor compares the signals representing the temperatures of the wheels on each axle to voltages representative of increases in temperature due to increases in magnitude of wheel malfunction.

7. The apparatus of claim 1 wherein the warning device comprises a selected one of a visual, audio and tactual alert of wheel malfunction to a driver of the vehicle.

8. The apparatus in claim 1 wherein the warning device provides multiple visual alerts in the form of different colored lights for each voltage representative of an increase in temperature corresponding to each magnitude of wheel malfunction.

9. The apparatus in claim 1 wherein the warning device provides multiple audio alerts in the form of a selected one of different tones, different tones combined with intensities and intensities for each voltage representative of an increase in temperature corresponding to each magnitude of wheel malfunction.

10. The apparatus in claim 1 wherein the location of the wheel dysfunction is identified by the position of the light in a panel of the different colored lights for each wheel.

11. The apparatus of claim 1 wherein the apparatus for monitoring wheel status on a vehicle resides entirely within the vehicle.

12. The apparatus of claim 1 wherein the apparatus for monitoring wheel status on a vehicle resides entirely within a towed vehicle and the warning device is positioned on a towed vehicle so that it can be viewed through rear-view mirrors in a towing vehicle.

13. The apparatus in claim 1 wherein the apparatus for monitoring wheel status on a vehicle resides in part in a towed vehicle and in part in a towing vehicle.

14. The apparatus of claim 1 wherein the connection between the temperature sensors and signal processor the signal processor and the warning device is a selected one of wired, wireless and both wired plus wireless.

15. An apparatus for monitoring wheel condition on a vehicle comprising:
paired thermocouples connected in series and mounted in thermal contact with an axle in dose proximity to right and left wheels;
a signal processor coupled to the thermocouple pair to analyze an output voltage representing a difference in temperature of the right and left wheels; and
a warning device coupled to the signal processor to alert a driver of the vehicle of a dysfunctional wheel.

16. The apparatus of claim 15 wherein paired thermocouples are mounted on a multiplicity of axles.

17. The apparatus in claim 15 wherein the output voltage representing the difference in temperature of right and left wheels is conditioned by amplifiers that are part of the signal processor.

18. The apparatus in claim 15 wherein the signal processor compares the output voltage representing the difference in temperature of right and left wheels on an axle to at least one voltage level that represents an increase in at least one temperature level due to at least one magnitude of dysfunction of a selected one of the right and left wheels.

19. The apparatus of claim 15 wherein the warning device for each wheel comprises multicolored lights to indicate a magnitude of the wheel dysfunction.

20. The apparatus of claim 19 wherein the multicolored lights comprise:
a green color indicating a normal temperature of the wheel and proper operation;
a yellow color indicating an abnormal temperature of the wheel and a warning magnitude of dysfunction; and
a red color indicating an extreme temperature of the wheel and a dangerous magnitude of dysfunction.

21. The apparatus of claim 19 wherein a location of the wheel dysfunction on the vehicle is indicated by a position of the light in a panel of the multicolored lights for each wheel.

22. A method to monitor the status of wheels on at least one axle on a vehicle comprising:
sensing through thermal conduction temperatures of the wheels on the at least one axle of the vehicle;
converting the temperatures of the wheels to signal voltages;
processing the signal voltages to determine dysfunctional temperatures of each wheel; and
displaying to a driver of the vehicle a magnitude and location of dysfunction of each wheel based on the processing.

23. The method of claim 22 wherein the processing of the signal voltages comprises:
comparing the signal voltages to voltage levels representing different temperature levels corresponding to different magnitudes of wheel dysfunction.

24. The method of claim 22 wherein the displaying the magnitude and location of dysfunction comprises:
displaying a different color in a multicolored light to indicate different magnitudes of dysfunction for each wheel and,
a position of the multicolored light on a panel of lights identifies the location of each wheel relative to other wheels.

25. The method of claim 24 wherein displaying a different color to indicate different magnitudes of dysfunction for each wheel comprises
indicating proper operation of the wheel with a green color;
indicating a warning condition of the wheel with a yellow color; and
indicating a danger condition of the wheel with a red color.

26. The method of claim 22 comprises sounding an audible alert for changes in the magnitudes of dysfunctions of any wheel for the driver of the vehicle.
